(19) United States
(12) Patent Application Publication
(10) Pub. No.: US 2013/0039429 A1
(43) Pub. Date: Feb. 14, 2013

(54) COMPUTER DISPLAY CONTENT CODING METHOD AND SYSTEM

(71) Applicant: XUE RONG HONG, Plano, TX (US)

(72) Inventor: XUE RONG HONG, Plano, TX (US)

(21) Appl. No.: 13/207,517

(22) Filed: Aug. 11, 2011

(51) Int. Cl. H04N 7/26

(52) U.S. Cl. 375/240.24; 375/E07.2

(57) ABSTRACT

A method is provided for encoding display data on a screen of a computer. The method includes separating display contents on the screen into a plurality of display blocks, and each block has a block type. The method also includes creating a block description table to describe characteristics of the plurality of display blocks, and classifying the plurality of display blocks into a predetermined number of different block types having different priorities when being encoded. Further, the method includes encoding the plurality of display blocks based on the different classified block types to generate encoded display blocks using compression algorithms corresponding to the different block types. The method also includes updating the block description table to include information on the classified display blocks, and encoding the updated block description table into an encoded block description table. The method further includes combining the encoded block description table and the encoded display blocks to generate encoded display data, and outputting the encoded display data.

### FIELD OF THE INVENTION

The present invention generally relates to computer graphic technologies and, more particularly, to the methods and systems for encoding and decoding computer display contents.

### BACKGROUND

Computers are now used in virtually all industries and computer graphics have been used to display texts, images, movies, video games, entertainments, and other 2-dimensional (2D) and 3-dimensional (3D) contents. Modern computers are also networked together to share information over the Internet, and the computer display contents in one computer may often need to be transmitted to another computer or other computers. That is, the computer display may need to be captured on one computer, and the captured contents may be encoded and transmitted to the other computers or storages over computer networks. The encoded display contents are decoded by the receiving computer in order to display the received display contents on the receiving computer.

However, the display contents are now becoming more complex, including larger amount of information, and requiring higher resolution, and conventional display codec (encoder and decoder) may be undesired for certain applications. The disclosed methods and systems are directed to solve one or more problems set forth above and other problems.

### BRIEF SUMMARY OF THE DISCLOSURE

One aspect of the present disclosure includes a method for encoding display data on a screen of a computer. The method includes separating display contents on the screen into a plurality of display blocks, and each block has a block type. The method also includes creating a block description table to describe characteristics of the plurality of display blocks, and classifying the plurality of display blocks into a predetermined number of different block types having different priorities when being encoded. Further, the method includes encoding the plurality of display blocks based on the different classified block types to generate encoded display blocks using compression algorithms corresponding to the different block types. The method also includes updating the block description table to include information on the classified display blocks, and encoding the updated block description table into an encoded block description table. The method further includes combining the encoded block description table and the encoded display blocks to generate encoded display data, and outputting the encoded display data.

Another aspect of the present disclosure includes a method for decoding encoded display data containing a plurality of display blocks encoded differently based on characteristics of the display blocks. The method includes obtaining the encoded display data and recovering from the encoded display data a block description table describing characteristics of the plurality of display blocks including corresponding block types and corresponding compression algorithms. The method also includes determining the corresponding block types of the plurality of encoded display blocks of the encoded display data based on the block description table. Further, the method includes decoding the plurality of encoded display blocks based on the corresponding block types to generate decoded display blocks according to the corresponding compression algorithms. The method also includes combining the decoded display blocks to generate decoded display data and outputting the decoded display data.

Another aspect of the present disclosure includes a computer-readable medium containing executable computer programs which performs a method for encoding display data on a screen of a computer when executed by the computer.

The method includes separating display contents on the screen into a plurality of display blocks, each having a block type, and creating a block description table to describe characteristics of the plurality of display blocks. The method also includes classifying the plurality of display blocks into a predetermined number of different block types having different priorities when being encoded, and encoding the plurality of display blocks based on the different classified block types to generate encoded display blocks using compression algorithms corresponding to the different block types. Further, the method includes updating the block description table to include information on the classified display blocks and encoding the block description table into an encoded block description table. The method also includes combining the encoded block description table and the encoded display blocks to generate encoded display data, and outputting the encoded display data.

Other aspects of the present disclosure can be understood by those skilled in the art in light of the description, the claims, and the drawings of the present disclosure.

### BRIEF DESCRIPTION OF THE DRAWINGS

FIG. 1 illustrates an exemplary computing environment incorporating certain disclosed embodiments;

FIG. 2 illustrates a block diagram of an exemplary computer consistent with the disclosed embodiments;

FIG. 3 illustrates an exemplary block diagram for coding operations consistent with the disclosed embodiments;

FIG. 4 illustrates an exemplary encoding process consistent with the disclosed embodiments;

FIG. 5 illustrates an exemplary classification process consistent with the disclosed embodiments; and

FIG. 6 illustrates an exemplary decoding process consistent with the disclosed embodiments.

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

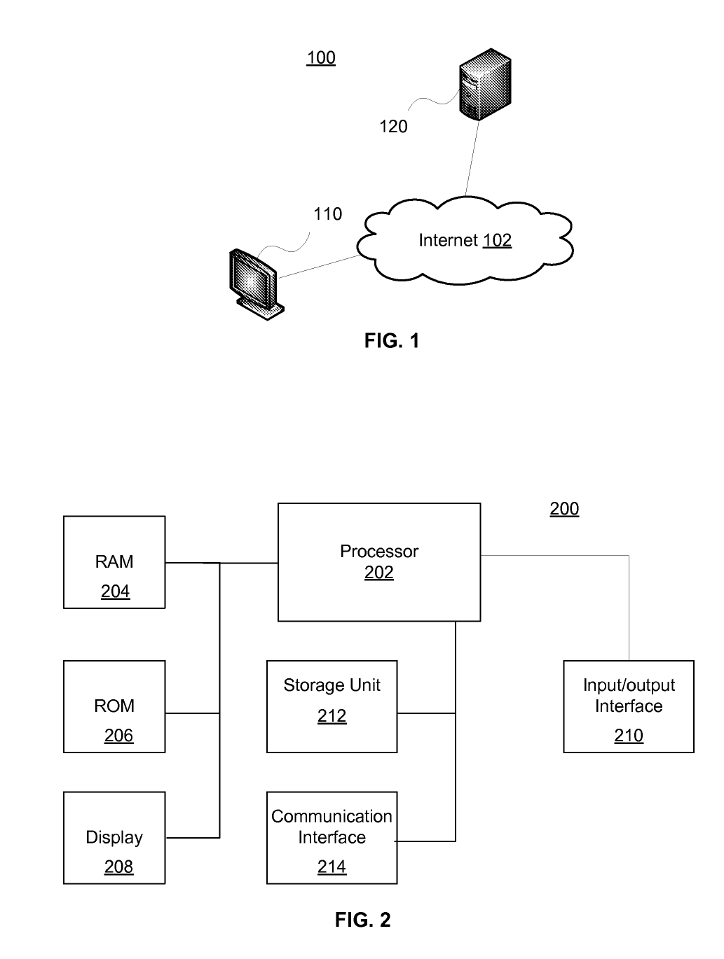

FIG. 1 illustrates an exemplary computing environment incorporating certain disclosed embodiments. As shown in FIG. 1, computing environment 100 includes the Internet 102 and a first computer 110 and a second computer 120 connected over the Internet 102. Other components may be added without departing from the principles of the disclosed embodiments. The Internet 102 may include any private and public computer networks interconnected using the standard transport control protocol/internet protocol (TCP/IP). Internet 102 may carry a large number of services over IP, such as the inter-linked hypertext documents of the world-wide-web (WWW) and hypertext transfer protocol (HTTP).

First computer 110 and second computer 120 may include any appropriate types of computers operated by users to perform computing, displaying, and networking over the Internet 102. For example, computers 110 and 120 may include desktop computers, notebook computers, tablets, smart phones, and other types of computing platforms and software programs. Although only two computers are shown in FIG. 1, any number of computers may be included. FIG. 2 illustrates a block diagram of an exemplary computer 200 that can be configured to implement first computer 110 and/or second computer 120.

As shown in FIG. 2, computer 200 (e.g., first computer 110, second computer 120) may include a processor 202, a random access memory (RAM) unit 204, a read-only memory (ROM) unit 206, a display interface 208, an input/output interface unit 210, a storage unit 212, and a communication interface 214. Other components may be added and certain devices may be removed without departing from the principles of the disclosed embodiments.

Processor 202 may include any appropriate type of general-purpose microprocessor, graphic processing unit (GPU), digital signal processor (DSP), microprocessor, and application specific integrated circuit (ASIC), etc. Processor 202 may execute sequences of computer program instructions to perform various processes associated with computer 200. The computer program instructions may be loaded into RAM 204 for execution by processor 202 from read-only memory 206 or storage unit 212. Processor 202 may control operation of computer 200.

Display 208 may include any appropriate computer monitor or display device, such as a liquid crystal display (LCD) and other video display devices and interface or display processor to control the computer monitor or display device. Display 208 may support various video decoding formats (e.g., H264.8) and may also include frame buffers. Further, input/output interface 210 may be provided for a user or users to input information into computer 200 or for the user or users to receive information from computer 200. For example, input/output interface 210 may include any appropriate input device, such as a remote control, a keyboard, a mouse, a microphone, a video camera or web-cam, an electronic tablet, a voice communication device, or any other optical or wireless input device. Input/output interface 210 may also include any appropriate output device, such as a speaker or any other audio device.

Storage unit 212 may include any appropriate storage device to store information used by computer 200, such as a universal serial bus (USB) drive, a hard disk, a flash disk, an optical disk, a CR-ROM drive, a DVD or other type of mass storage media, or a network storage. Further, communication interface 214 may provide communication connections such that computer 200 may be accessed remotely and/or communicate with other systems through the Internet 102 or other communication networks via various communication protocols, such as TCP/IP and hyper text transfer protocol (HTTP).

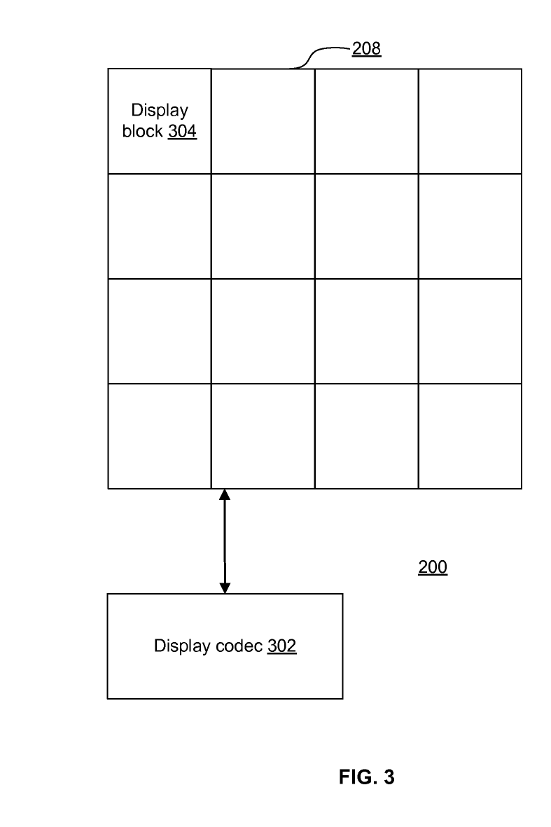

Part or all of the components in computer 200 (e.g., first computer 110 and/or second computer 120) may be implemented via hardware, software, or a combination of the hardware and the software. In certain embodiments, computer 200 may perform display content encoding and decoding operations. FIG. 3 illustrates an exemplary block diagram for such operations.

As shown in FIG. 3, computer 200 may use a display codec 302 to perform content encoding and/or decoding operations on display 208. The term display codec, as used herein, may refer to any encoder and/or decoder configured to encode and/or decode the display contents of a computer screen, such as text, image, video, and/or audio contents. Other types of contents may also be included.

In operation, display contents on display 208, i.e., a screen display, may be separated into a plurality of display blocks 304, and display codec 302 may encode and/or decode display contents based on the characteristics of the display blocks. For example, a display block may have a certain type. In certain embodiments, the display blocks may be separated into three types of data, a graphic type, a photo type, and a video type. A graphic type of data may be from a graphic data source, such as computer programs, and the contents of the graphic type data may be static and may need high resolution, such as text and window frames.

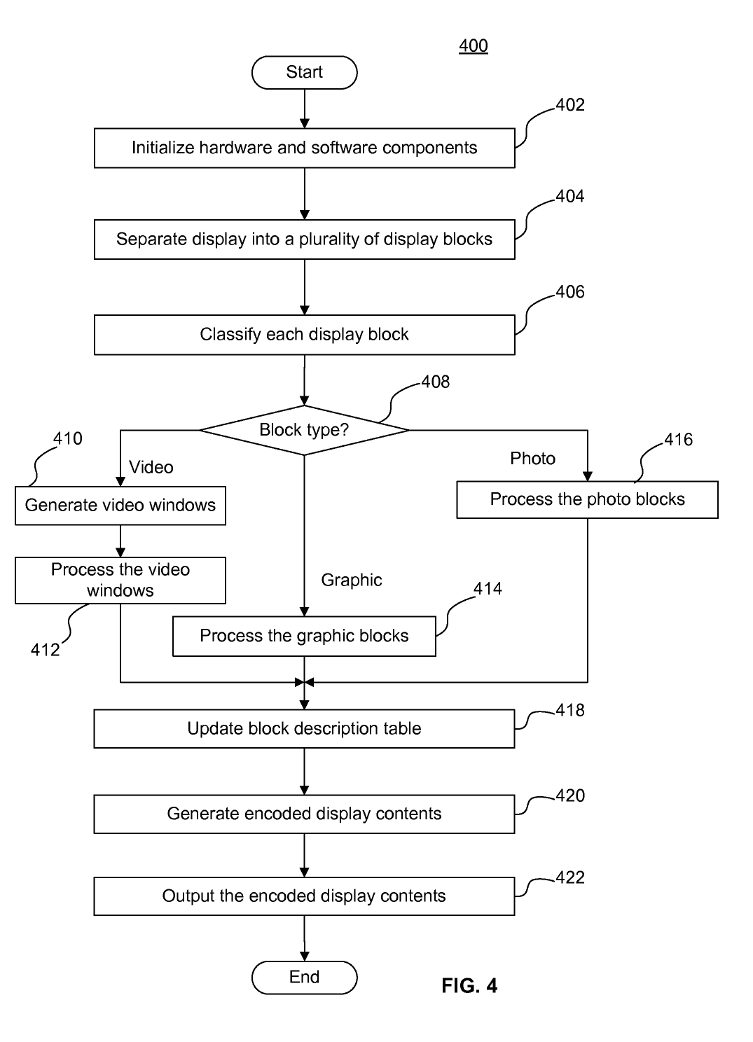

A photo type of data may be from a photo data source, such as a photo camera, and the contents of the photo type data may be static with a reasonable resolution. Further, a video type of data may be from a video data source, such as a video camera, and the contents of the video type data may be dynamic with a limited resolution (e.g., the resolution may be reduced according to available bandwidth for transmitting the video type data). Other types of data may also be used. Computer 200 may use the type information and other characteristics of the display blocks to encode and/or decode the display contents. FIG. 4 illustrates an exemplary encoding process 400 performed by computer 200 using the display codec 302.

As shown in FIG. 4, at the beginning, computer 200 may initialize hardware and software components (402). For example, computer 200 may initialize certain display devices, the display codec 302, and other related display and communication devices, and may determine or select a display screen (e.g., a screen frame, a screen image, etc.) to be encoded. Computer 200 may also initialize any appropriate data structure. For example, computer 200 may create a block description table associated with the encoding and/or decoding processes. A block description table may include any appropriate data structure configured to describe characteristics of each display block, such block type, position, size, and/or encoding method, etc. Further, computer 200 may separate or divide the display screen into a plurality of display block (404). For example, computer 200 may separate the display screen into 2ⁿ×2ⁿ (n=1, 2, 3, 4 . . . ) display blocks, such as 4×4, 8×8, and 16×16, etc. Other sizes and numbers may also be used.

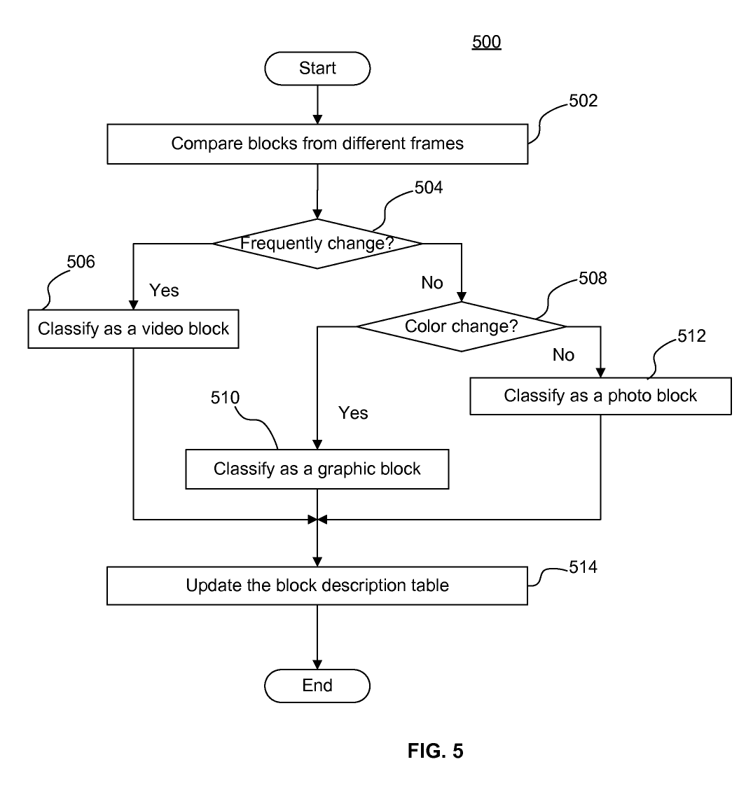

Further, computer 200 may classify each separated display block (406). For example, computer 200 may classify each display block into a particular type, such as one of a graphic type, a photo type, and a video type. Computer 200 may perform the classification operation using certain predetermined algorithms. FIG. 5 illustrates an exemplary classification process 500 performed by computer 200.

As shown in FIG. 5, computer 200 may compare display blocks from different frames (502). For example, computer 200 may compare blocks of a current frame with blocks from a previous frame at a certain time interval and at the same positions within the display screen. The time interval may be configured by a user of computer 200 or may be automatically set by computer 200 based on particular applications. In certain embodiments, the time interval may be set to multiple frame intervals to reduce processing load, or may be set to a single frame interval to increase processing quality.

The comparison results may reflect whether the content of a particular block of the current frame is changed. For example, if any pixel from the particular block changes when compared with the previous frame at the certain time interval, the content of the particular block may be considered as being changed. The comparison results may be stored to form comparison records to be used for further determination.

Further, computer 200 may determine whether the content of a particular block of the current frame changes frequently (504). From the stored comparison records, computer 200 may determine the total number of changes for the particular block within a predetermined time period. If the total number of changes exceeds a threshold number, computer 200 may determine that the content of the particular block of the current frame changes frequently; if the total number of changes does not exceed the threshold, computer 200 may determine that the content of the particular block of the current frame does not change frequently.

If computer 200 determines that a display block changes frequently (504; Yes), computer 200 may classify the display block as a video block (506). On the other hand, if computer 200 determines that the display block does not change frequently (504; No), computer 200 may further determine whether there are any abrupt changes in pixel colors within the block (508). For example, computer 200 may compare neighboring pixels in both vertical and horizontal directions to determine whether the color values (e.g., R, G, B values) between two neighboring pixel changes abruptly (i.e., a change exceeding a threshold).

If computer 200 determines that there is abrupt color change between neighboring pixels (508; Yes), computer 200 may classify the display block as a graphic block (510). On the other hand, if computer 200 determines that there is no abrupt color change between neighboring pixels (508; No), computer 200 may classify the display block as a photo block (512).

Thus, computer 200 may classify each display block of a current display frame as one of a video block, a graphic block, and a photo block. Further, computer 200 may update the block description table to reflect the current classification of each display block (514).

Returning to FIG. 4, after each display block is classified (406), computer 200 may determine a block type of a particular block (408). For example, computer 200 may read out each display block in sequence and use the block information from the block description table to determine the block type of the particular block in processing. If computer 200 determines that the block is a video block (408; Video), computer 200 may process the block using a defined algorithm for video data. For example, computer 200 may first combined together neighboring or near-by video blocks to generate one or more video windows (410).

Further, computer 200 may process or encode the video windows (412). When encoding the video windows, computer 200 may use a frame rate or continuality as a priority (i.e., to preserve the frame rate whenever possible while to adjust resolution according to available bandwidth for data transmission) and may compress the video windows using compression algorithms such as MPEG2, MPEG4, and H264, etc.

If computer 200 determines that the block is a graphic block (408; Graphic), computer 200 may process or encode the graphic block using a defined algorithm for graphic data (414). When encoding the graphic blocks, computer 200 may use resolution as a priority (i.e., to preserve the resolution whenever possible) and may use loss-less compression algorithms such as ZLIB, 7Z, and PNG, etc. Further, because the contents of the graphic blocks are mostly static, only changed contents over previous corresponding blocks may be compressed and transmitted. All graphic blocks may be combined together first and compressed using a determined compression algorithm.

If computer 200 determines that the block is a photo block (408; Photo), computer 200 may process or encode the photo block using a defined algorithm for photo data (416). When encoding the photo blocks, computer 200 may use bandwidth as a priority (i.e., to encode data based on available limited bandwidth for data transmission) and may use loss compression algorithms such as GIF, JPEG, and JPEG2000, etc. Further, because the contents of the photo blocks are also mostly static, only changed contents over previous corresponding blocks may be compressed and transmitted. All photo blocks may be combined together first and compressed using a determined compression algorithm.

After all display blocks are processed (e.g., encoded or compressed), computer 200 may update the block description table (418). For example, computer 200 may record block position, block type, encoding method, priority, and size of each display block and/or of video windows.

Further, computer 200 may generate encoded display contents (420). Computer 200 may combine together the differently-encoded video windows, graphic blocks, and photo blocks to generate encoded display contents. Computer 200 may also use a predetermined loss-less compression algorithm to compress the block description table and add the compressed block description table to the encoded display contents. Further, computer 200 may output the encoded display contents including the compressed block description table (422).

Computer 200 may output the encoded display contents over a computer network (the Internet 102) to another computer, such as between first computer 110 and second computer 120. Alternatively or optionally, computer 200 may also output the encoded display contents to a local storage (e.g., storage 212) or network storage to be stored. Other output devices may also be used.

When outputting the encoded display contents over a communication channel (e.g., over the computer network), computer 200 may detect or monitor the data rate of the encoded data, the available bandwidth for transmitting the encoded data, and/or the work load of the display codec 302 or other devices. If the available bandwidth is not sufficient for transmitting the encoded data or the work load is heavy, computer 200 may perform certain pre-processing before encoding or compressing the display data to reduce the data rate or data amount. For example, for video windows, computer 200 may downscale the video windows and then compress the downscaled video windows. For graphic blocks and photo blocks, computer 200 may reduce the frame rate of the graphic blocks and photo blocks. Other means for reducing the encoded data rate or data amount may also be used.

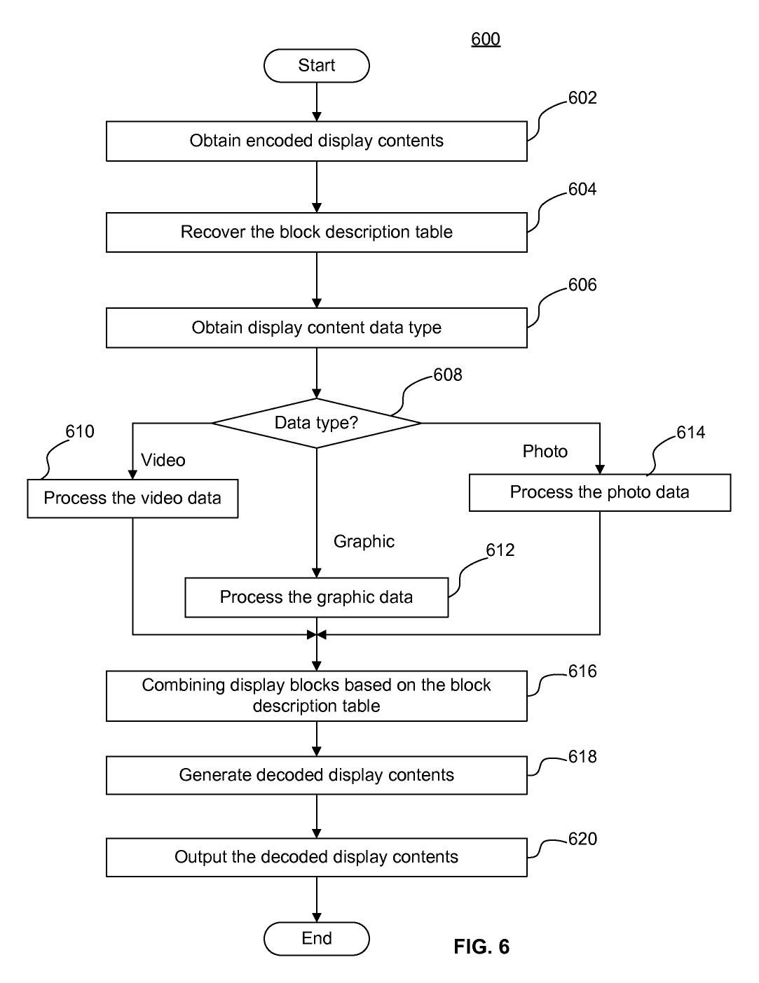

In addition to the encoding process, computer 200 may also perform a corresponding decoding process to recover the encoded display contents. FIG. 6 illustrates an exemplary decoding process 600 performed by the computer 200 using the display codec 302.

As shown in FIG. 6, at the beginning, computer 200 may obtain encoded display contents (602). For example, computer 200 may obtain the encoded display contents over the Internet 102 from another computer or from a local or remote storage. Any appropriate data sources may be used.

After obtaining the encoded display contents (602), computer 200 may recover the block description table (604). For example, computer 200 may separate the encoded block description table from the encoded display contents and uncompress or decode the block description table based on the predetermined algorithm used for the block description table. Computer 200 may also separate the encoded video windows, graphic blocks, and photo blocks. Based on the recovered block description table, computer 200 may obtain display content data type for the data to be processed (606) and determine a data type of each block or video window (608).

If computer 200 determines a video type (608; Video), computer 200 may process the determined video data (610). For example, computer 200 may decode or uncompress the encoded or compressed video windows to recover the original video blocks using the determined algorithm used for video data. If computer 200 determines a graphic type (608; Graphic), computer 200 may process the determined graphic data (612). Computer 200 may decode or uncompress the encoded or compressed graphic blocks to recover the original graphic blocks using the determined algorithm used for graphic data.

Further, if computer 200 determines a photo type (608; Video), computer 200 may process the determined photo data (614). Computer 200 may decode or uncompress the encoded or compressed photo blocks to recover the original photo blocks using the determined algorithm used for photo data.

After all original display blocks are recovered, computer 200 may combine or assemble the display blocks based on the information in the block description table (616) and generate the display contents as a display frame or a display screen (618). Further, computer 200 may output the decoded display contents (620). For example, computer 200 may output the decoded display contents to a display device (e.g., display 208) to present the display contents to a user of computer 200 or may output the decoded display contents to a computer program or other devices for further processing.

By using the disclosed methods and systems, display screen data can be dynamically analyzed and classified using flexible time intervals and be encoded or compressed based on the contents. When the contents require continuality, the continuality is used as the priority for processing; when the contents require resolution, the resolution is used as the priority for processing. Thus, a higher compression rate can be achieved by the disclosed systems than conventional systems to suit different bandwidth requirements of the computer networks transmitting the encoded display screen data.

Further, the disclosed methods and systems may be able to use different encoding and decoding hardware and to adjust according to the hardware and/or software environment. Other applications and advantages are obvious to those skilled in the art.

What is claimed is:

1. A method for encoding display data on a screen of a computer, comprising:
separating display contents on the screen into a plurality of display blocks, each block having a block type;
creating a block description table to describe characteristics of the plurality of display blocks;
classifying the plurality of display blocks into a predetermined number of different block types having different priorities when being encoded;
encoding the plurality of display blocks based on the different classified block types to generate encoded display blocks using compression algorithms corresponding to the different block types;
updating the block description table to include information on the classified display blocks;
encoding the updated block description table into an encoded block description table;
combining the encoded block description table and the encoded display blocks to generate encoded display data; and
outputting the encoded display data.

2. The method according to claim 1, wherein:
the block type is one of a video block type, a graphic block type, and a photo block type.

3. The method according to claim 2, wherein:
the video block type has a frame rate as the corresponding priority;
the graphic block type has a resolution as the corresponding priority; and
the photo block type has bandwidth as the corresponding priority.

4. The method according to claim 2, wherein the classifying includes:
determining whether a particular display block changes frequently;
when the particular display block changes frequently, classifying the particular display block as a video block;
when the particular display block does not change frequently, determining whether the particular display block has any abrupt change in pixel color;
when there is any abrupt change in pixel color, classifying the particular display block as a graphic block; and
when there is not any abrupt change in pixel color, classifying the particular display block as a photo block.

5. The method according to claim 3, wherein the encoding the plurality of display blocks further includes:
compressing video blocks using a loss compression algorithm; and
compressing graphic blocks using a loss-less compression algorithm.

6. The method according to claim 3, wherein the encoding the plurality of display blocks further includes:
compressing video blocks according to one of MPEG2, MPEG4, and H264;
compressing graphic blocks according to one of ZLIB, 7Z, and PNG; and
compressing photo blocks according to one of GIF, JPEG, and JPEG2000.

7. The method according to claim 5, wherein the compressing video blocks further includes:
combining the video blocks into a plurality of video windows; and
compressing the plurality of video windows.

8. The method according to claim 7, further including:
monitoring a bandwidth condition; and
when the bandwidth condition is not desired, downscaling the video windows before compressing the video windows.

9. A method for decoding encoded display data containing a plurality of display blocks encoded differently based on characteristics of the display blocks, the method comprising:
obtaining the encoded display data;
recovering from the encoded display data a block description table describing characteristics of the plurality of display blocks including corresponding block types and corresponding compression algorithms;
determining the corresponding block types of the plurality of encoded display blocks of the encoded display data based on the block description table;
decoding the plurality of encoded display blocks based on the corresponding block types to generate decoded display blocks according to the corresponding compression algorithms;
combining the decoded display blocks to generate decoded display data; and
outputting the decoded display data.

10. The method according to claim 9, wherein:
the block types include a video block type, a graphic block type, and a photo block type.

11. The method according to claim 10, wherein the encoding the plurality of display blocks further includes:
uncompressing video blocks according to one of MPEG2, MPEG4, and H264;
uncompressing graphic blocks according to one of ZLIB, 7Z, and PNG; and
uncompressing photo blocks according to one of GIF, JPEG, and JPEG2000.

12. The method according to claim 11, wherein the uncompressing video blocks further includes:
uncompressing a plurality of video windows; and
recovering the video blocks from the plurality of video windows.

13. A computer-readable medium containing executable computer programs, when executed by a computer, performing a method for encoding display data on a screen of the computer, the method comprising:
separating display contents on the screen into a plurality of display blocks, each block having a block type;
creating a block description table to describe characteristics of the plurality of display blocks;
classifying the plurality of display blocks into a predetermined number of different block types having different priorities when being encoded;
encoding the plurality of display blocks based on the different classified block types to generate encoded display blocks using compression algorithms corresponding to the different block types;
updating the block description table to include information on the classified display blocks;
encoding the block description table into an encoded block description table;
combining the encoded block description table and the encoded display blocks to generate encoded display data; and
outputting the encoded display data.

14. The computer-readable medium according to claim 13, wherein:
the block type is one of a video block type, a graphic block type, and a photo block type.

15. The computer-readable medium according to claim 14, wherein:
the video block type has a frame rate as the corresponding priority;
the graphic block type has a resolution as the corresponding priority; and
the photo block type has bandwidth as the corresponding priority.

16. The computer-readable medium according to claim 14, wherein the classifying includes:
determining whether a particular display block changes frequently;
when the particular display block changes frequently, classifying the particular display block as a video block;
when the particular display block does not change frequently, determining whether the particular display block has any abrupt change in pixel color;
when there is any abrupt change in pixel color, classifying the particular display block as a graphic block; and
when there is not any abrupt change in pixel color, classifying the particular display block as a photo block.

17. The computer-readable medium according to claim 15, wherein the encoding the plurality of display blocks further includes:
compressing video blocks using a loss compression algorithm; and
compressing graphic blocks using a loss-less compression algorithm.

18. The computer-readable medium according to claim 15, wherein the encoding the plurality of display blocks further includes:
compressing video blocks according to one of MPEG2, MPEG4, and H264;
compressing graphic blocks according to one of ZLIB, 7Z, and PNG; and
compressing photo blocks according to one of GIF, JPEG, and JPEG2000.

19. The computer-readable medium according to claim 18, wherein the compressing video blocks further includes:
combining the video blocks into a plurality of video windows; and
compressing the plurality of video windows.

20. The computer-readable medium according to claim 19, the method further including:
monitoring a bandwidth condition;
when the bandwidth condition is not desired, downscaling the video windows before compressing the video windows.
